(19) United States
(12) Patent Application Publication
(10) Pub. No.: US 2021/0279980 A1
(43) Pub. Date: Sep. 9, 2021

(54) SYSTEMS AND METHODS FOR TRAIL RATING

(71) Applicant: VECTORFORM, LLC, Royal Oak, MI (US)

(72) Inventors: Kurt M. Steckling, Birmingham, MI (US); Damian Francis, Ypsilanti, MI (US); Ashley Howell, Milford, MI (US); Jeffrey Meador, Birmingham, MI (US); Brooke Colleen Klimek, Royal Oak, MI (US); Jason A. Vazzano, Bloomfield Hills, MI (US)

(21) Appl. No.: 17/192,304

(22) Filed: Mar. 4, 2021

Related U.S. Application Data
(60) Provisional application No. 62/984,834, filed on Mar. 4, 2020.

(51) Int. Cl. G07C 5/08; G07C 5/00; G06F 16/29

(52) U.S. Cl. CPC G07C 5/0808; G06F 16/29; G07C 5/008

(57) ABSTRACT

A trail rating system according to an example of the present disclosure includes, among other things, an interface module in communication with at least one vehicle, a data module operable to access one or more gear profiles, operator profiles and/or trail profiles, a trail rating module operable to generate at least one trail score, gear score, driver score and trail map in response to operation of the at least one vehicle over at least predefined route corresponding to a respective one of the trail profiles, and a display module operable to communicate information relating to the at least one trail score, gear score, driver score and trail map. Methods of generating trail scores, gear scores, driver scores and trail maps are also disclosed.

### CROSS-REFERENCE TO RELATED APPLICATION

The present disclosure claims the benefit of U.S. Provisional Patent Application No. 62/984,834, filed Mar. 4, 2020, incorporated herein in its entirety.

### BACKGROUND

This disclosure relates to vehicle performance, including systems and methods of rating or scoring vehicles, vehicle components, and drivers relating to operation over trails and other routes.

Duration may be measured during operation of a vehicle over a course. The measured duration may be utilized as an indication of vehicle or driver performance

### SUMMARY

A trail rating system according to an example of the present disclosure includes, among other things, an interface module in communication with at least one vehicle, a data module operable to access one or more gear profiles, operator profiles and/or trail profiles, a trail rating module operable to generate at least one trail score, gear score, driver score and trail map in response to operation of the at least one vehicle over at least predefined route corresponding to a respective one of the trail profiles, and a display module operable to communicate information relating to the at least one trail score, gear score, driver score and trail map.

A trail rating system according to an example of the present disclosure includes a processor and memory operable to execute a trail rating environment. The trail rating environment includes an interface module operable to communicate with a vehicle interface of at least one vehicle, a data module operable to access one or more gear profiles, one or more operator profiles and one or more trail profiles, a trail rating module operable to generate at least one trail score, at least one gear score, at least one driver score and at least one trail map in response to operation of the at least one vehicle over at least one predefined route, wherein the at least one predefined route corresponds to a respective one of the one or more trail profiles, and a display module including a user interface operable to display information relating to the at least one trail score, the at least one gear score, the at least one driver score and the at least one trail map.

In a further embodiment of any of the foregoing embodiments, the interface module is operable to receive data corresponding to two or more of the following over a communication path established between the interface module and the vehicle interface: speed, torque, RPM, pressure, temperature, fuel level, traction control reading, traction control setting, and drive mode.

In a further embodiment of any of the foregoing embodiments, the vehicle interface comprises an on-board diagnostics port.

In a further embodiment of any of the foregoing embodiments, the interface module is operable to obtain operational data relating to operation of the at least one vehicle from one or more sensors. The one or more sensors include at least one of the following: a GPS module, an altimeter, a gyroscope and an accelerometer. The operational data includes at least one of the following: location, ambient temperature, precipitation, altitude, soil condition and/or topography.

In a further embodiment of any of the foregoing embodiments, the data module is operable to access the one or more gear profiles, the one or more operator profiles and the one or more trail profiles in a database.

In a further embodiment of any of the foregoing embodiments, the data module is operable to edit the one or more gear profiles, the one or more operator profiles and the one or more trail profiles in the database in response to user interaction.

In a further embodiment of any of the foregoing embodiments, each of the one or more gear profiles corresponds to a configuration of equipment associated with the at least one vehicle. Each of the one or more operator profiles corresponds to a unique operator identity. Each of the one or more trail profiles corresponds to a predefined route associated with a set of geometric coordinates.

In a further embodiment of any of the foregoing embodiments, the display module is operable to cause the configuration of equipment to be set for the respective one or more gear profiles in response to user interaction.

In a further embodiment of any of the foregoing embodiments, the configuration of equipment comprises aftermarket equipment.

In a further embodiment of any of the foregoing embodiments, the database is operable to store a plurality of gear profiles associated with a plurality of vehicles. The trail rating module is operable to generate the at least one gear score based on a comparison of each gear profile of the plurality of gear profiles in the database having one or more aftermarket hardware components in common with the one or more gear profiles.

In a further embodiment of any of the foregoing embodiments, the at least one vehicle includes an all-terrain vehicle or an off-road vehicle.

A method of trail rating for a vehicle according to an example of the present disclosure includes accessing at least one gear profile corresponding to a configuration of equipment of a respective vehicle, accessing at least one operator profile, accessing at least one trail profile corresponding to at least one predefined route, wherein the at least one predefined route is associated with a set of geometric coordinates, obtaining data from a vehicle interface of the respective vehicle in operation over the at least one predefined route, generating at least one trail score, at least one gear score, at least one driver score and at least one trail map based on the obtained data, and displaying information in a user interface relating to the at least one trail score, the at least one gear score, the at least one driver score and the at least one trail map.

In a further embodiment of any of the foregoing embodiments, the method includes setting the configuration of equipment in response to user interaction with the user interface.

In a further embodiment of any of the foregoing embodiments, the configuration of equipment comprises aftermarket equipment. The vehicle is an all-terrain vehicle or an off-road vehicle.

In a further embodiment of any of the foregoing embodiments, the step of accessing the at least one gear profile includes accessing the at least one gear profile from a plurality of gear profiles in a database. The step of generating the at least one trail score occurs in response to comparing each gear profile of the plurality of gear profiles in the database having one or more aftermarket hardware components in common with the at least one gear profile.

In a further embodiment of any of the foregoing embodiments, the step of accessing the at least one trail profile includes accessing the at least one trail profile in the database, wherein the database is operable to store a plurality of trail profiles. The method includes generating a list of recommended equipment for the at least one trail profile based on aggregated gear scores in the database and a total number of successful trail runs performed by using the list of recommended equipment for a population of gear profiles in the database.

In a further embodiment of any of the foregoing embodiments, the method includes setting a start and a finish of a trail route associated with the at least one predefined route in response to user interaction with the user interface, and declaring a successful run in response to determining completion of the trail route with the configuration of equipment.

In a further embodiment of any of the foregoing embodiments, the step of generating the at least one trail score includes generating a plurality of trail scores for the at least one predefined route, each of the plurality of trail scores associated with the at least one operator profile. The step of generating the at least one driver score is based on averaging the plurality of the trail scores.

In a further embodiment of any of the foregoing embodiments, the obtained data corresponds to two or more of the following: speed, torque, RPM, pressure, temperature, fuel level, traction control reading, traction control setting, and drive mode. The step of generating the at least one trail score includes generating a roll rating associated with gyroscopic data from a gyroscope associated with the vehicle, generating a pitch rating associated with the gyroscopic data, generating a speed rating associated with the speed and an elapsed time, generating a traction rating associated with the traction control reading and the traction control setting, and generating a drive mode rating associated with the drive mode.

In a further embodiment of any of the foregoing embodiments, the method includes generating a first indicator based on gyroscopic data from a gyroscope associated with the vehicle, generating a second indicator based on speed from an accelerometer associated with the vehicle, displaying the first indicator on the at least one trail map to identify a first segment along the at least one predefined route, and displaying the second indicator on the at least one trail map to identify a second segment along the at least one predefined route.

In a further embodiment of any of the foregoing embodiments, the method includes generating a filtered list of gear equipment based on aggregated gear scores in the database and according to at least one criterion being set by user interaction with the user interface, and displaying the filtered list of gear equipment.

The various features and advantages of this disclosure will become apparent to those skilled in the art from the following detailed description. The drawings that accompany the detailed description can be briefly described as follows.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example system for trail rating.

FIG. 2 illustrates an example trail rating environment of the system of FIG. 1.

FIG. 2A illustrates another example trail rating environment.

FIG. 3 illustrates an exemplary process for trail rating.

FIG. 4 illustrates another exemplary process for trail rating.

FIG. 5 illustrates an exemplary process for driver and gear rating.

FIG. 6 illustrates an exemplary process for generating a trail map.

FIG. 7 illustrates an exemplary display screen including a live view of a trail map.

FIG. 8 illustrates an exemplary display screen including various performance characteristics associated with the trail map of FIG. 7.

FIG. 9 illustrates an exemplary display screen including a historic view of a trail map.

FIG. 10 illustrates an exemplary display screen including trail scores.

FIG. 11 illustrates an exemplary display screen relating to gear selection.

FIG. 12 illustrates an exemplary display screen including gear scores.

FIG. 13 illustrates an exemplary display screen for querying gear.

FIG. 14 illustrates an exemplary display screen for presenting results of a query for gear.

### DETAILED DESCRIPTION

Disclosed are systems and methods that can be utilized to determine and rate vehicle, gear or equipment, and driver or operator performance during operation of the vehicle on one or more trails, routes, courses or paths. The system is configured to collect various data and information during operation of the associated vehicles on real-world trails and other routes, for example The system is configured to generate one or more indicators such as ratings or scores based at least in part on the collected data.

Vehicle operators can interact with the system to obtain insightful information on the trails and associated vehicle configuration or profile, including a review of any indicators and ratings of interest. The operator can interact with the system to compare the indicators and ratings to past performance, as well as compare the performance of other vehicle configurations and/or operators for any of the trail profiles stored in the system. Although the techniques disclosed herein primarily refer to trails or trail runs, it should be understood that the disclosed techniques can be utilized with any route, course or path.

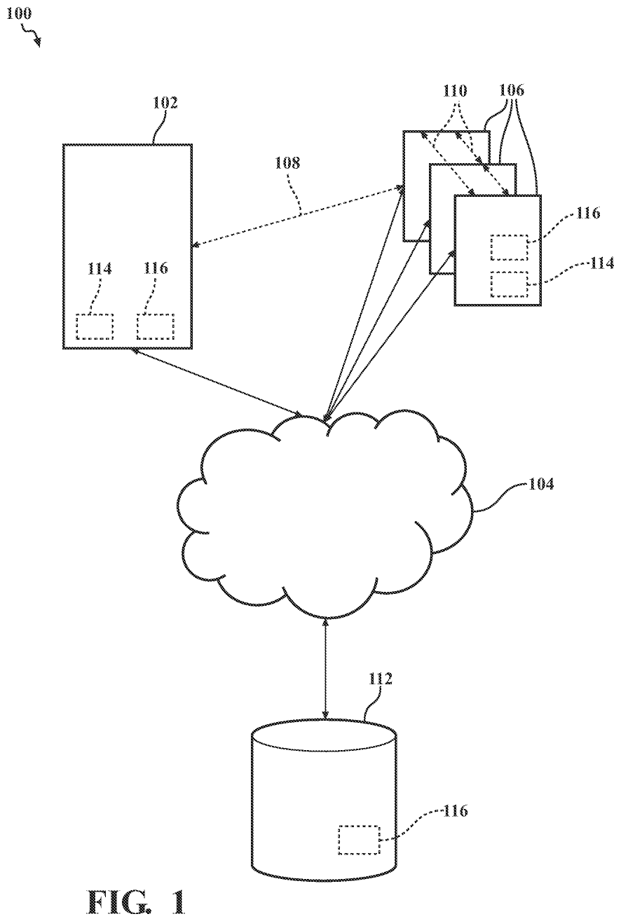

FIG. 1 illustrates an exemplary computing architecture or system 100 for trail rating. Utilizing the techniques disclosed herein, one or more trail scores, driver scores, gear scores and/or trail maps associated with operation of vehicles across one or more trails or predefined routes can be generated and communicated to a driver, operator or another user of the system 100.

The system 100 includes at least one host computer or device 102 configured to execute one or more software programs. In examples, the host device 102 is more than one device jointly configured to process software instructions serially or in parallel. In some examples, the host device 102 is operable to communicate with one or more networks such as a network 104 comprised of one or more computing devices. The network 104 may be a private local area network (LAN), a private wide area network (WAN), the Internet, a mesh network, a cloud computing network, or any other network as is known in the art.

The system 100 includes one or more client computers or devices 106. The host device 102 and the client devices 106 can include one or more of a computer processor, memory, storage means, network device and input and/or output devices and/or interfaces according to some examples. The memory may, for example, include UVPROM, EEPROM, FLASH, RAM, ROM, DVD, CD, a hard drive, or other computer readable medium which may store data and/or the rating and map functionality disclosed herein. In examples, the host device 102 and client devices 106 include an input device, such as a keyboard and mouse, and one or more output devices such as a monitor, speakers, printers, etc. The host device 102 and client devices 106 may be a desktop computer, a laptop computer, a mobile device such as a smart phone or a tablet, or any other computer device. The mobile device can be configured to execute an iOS or Android OS front end, for example, and a backend linked to the network 104 or a cloud computing environment, for example. In examples, the host device 102, client devices 106 and/or portions thereof are implemented utilizing hardware virtualization techniques.

Each host device 102 and client devices 106 includes a respective network interface. The network interface facilitates communication with the other systems and/or components of the network 104 utilizing various communications protocols such as GATT (Generic Attribute Profile), Transmission Control Protocol/Internet Protocol (TCP/IP), User Datagram Protocol (UDP), hypertext transfer protocol (HTTP), simple mail transfer protocol (SMTP), file transfer protocol (FTP), and Message Queuing Telemetry Transport (MQTT), for example. In examples, the client devices 106 are configured to communicate with the host device 102 directly via a direct client interface 108 or over the network 104. In other examples, the one or more client devices 106 are configured to communicate with each other directly via a peer-to-peer interface 110.

The system 100 can include storage system(s) 112. The storage system 112 is operable to store or otherwise provide data such as formatted and/or unformatted text files, database files, video, still images, audio and other media files to other computing devices. In examples, the storage system 112 is a storage area network device (SAN) configured to communicate with the host device 102 and/or client devices 106 directly or over the network 104. In other examples, the storage system 112 is located within the host device 102 or within at least one of the client devices 106. The storage system 112 may be configured to store one or more of computer software instructions, data, database files, video images or other media files, and configuration information, for example. In other examples, the host device 102 and/or client devices 106 are configured to communicate information, media and other data in a cloud computing environment or to one or more third-party data locations via one or more web services.

The system 100 is operable to store information and other data in one or more databases 116, including any of the information and data disclosed herein, at a central or distributed location, such as the storage system 112, host device 102 and/or client devices 106. In examples, each database 116 is a relational database. Each database 116 can be linked to one or more files stored in the storage system 112 or another portion of the system 100.

In examples, the system 100 is a client-server architecture configured to execute device software on the host device 102, including any of the functionality disclosed herein, which is accessible by the client devices 106 using either a thin client application or a web browser executing on the client devices 106. In examples, the host device 102 loads the device software instructions from local storage, or the storage system 112 into memory and executes the device software using processor(s) of the host device 102.

In examples, the host device 102 and/or client devices 106 are operable to access and locally run software and provide a trail rating environment 114 and/or portions thereof. The trail rating environment 114 is operable to execute any of the functionality disclosed herein.

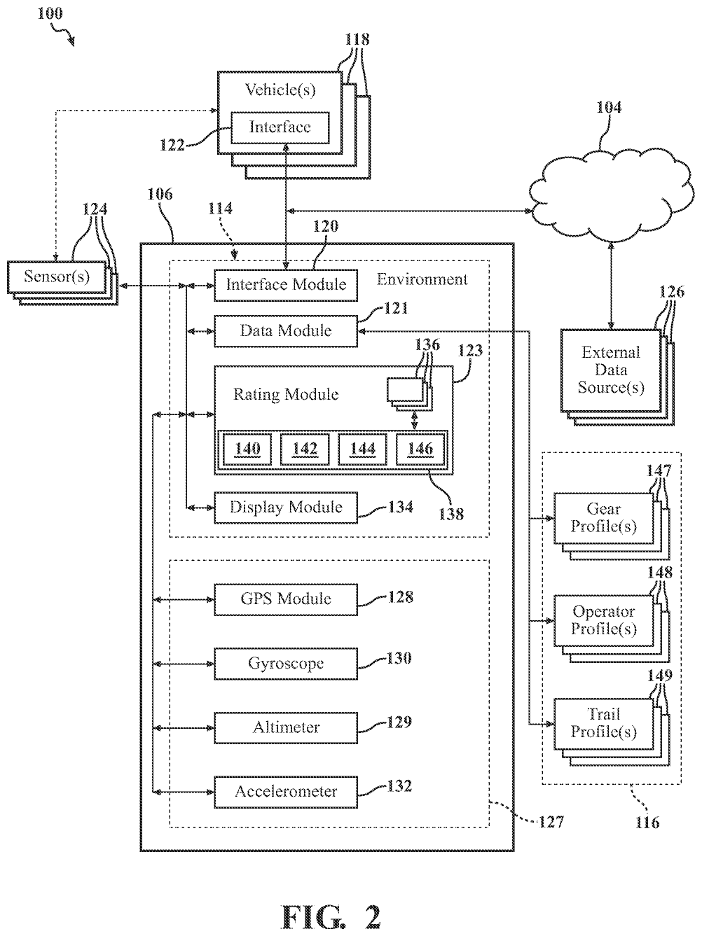

Referring to FIG. 2, with continuing reference to FIG. 1, each client device 106 is operable to communicate with one or more vehicles (or systems) 118. Example vehicles include on-road or street legal cars and trucks, all-terrain vehicles (ATV), off-road vehicles (ORV), electric bicycles sometimes referred to as “ebikes” and other forms of personal mobility, which can be stock or modified original equipment manufacturer (OEM), prototype or custom platforms.

Each client device 106 is operable to execute or otherwise interact with the environment 114. The environment 114 can be implemented via software, hardware, or a combination of hardware and software. In examples, the environment 114 is incorporated into the client device 106. In other examples, the environment 114 (or any of the modules and functionality disclosed herein) is a separate and distinct hardware device in communication with the client device 106 (e.g., mobile phone), and data and other information collected by the environment 114 can be communicated to the client device 106 utilizing any of the communications techniques disclosed herein, such as Bluetooth Low Energy (BLE) or Wi-Fi.

The environment 114 can include at least a client interface module 120, a data module 121, a display module 134 and a trail rating module 123 coupled to each other and/or any of the various modules and devices of the system 100 disclosed herein. The environment 114 can be a standalone system, incorporated or executed by the client device(s) 106, host device 102, and/or distributed across the various devices of the system 100, for example.

The client interface module 120 is operable to communicate wired and/or wirelessly with the network 104 and a vehicle interface 122 of each respective vehicle 118. Example wired and/or wireless communications techniques can include hardwire connections (e.g., Ethernet), and wireless connections utilizing various communications protocols, such as Wi-Fi, Bluetooth including BLE, ZigBee, and 2G/3G/4G/5G cellular protocols. One would understand how to configure the various devices and modules of the system 100 to communicate with each other in view of the teachings disclosed herein.

In examples, the vehicle interface 122 is a standardized interface such as an on-board diagnostics (OBD) port (e.g., OBD-II). OBD ports are known, and one would understand how to configure the interface module 120 and environment 114 to obtain data and other information from each vehicle interface 122 in view of the teachings disclosed herein. The interface module 120 can include a dongle or diagnostics connector that mates or otherwise communicates with a connector of the OBD port of the vehicle interface 122. The client interface module 120 and vehicle interface 122 can incorporate any of the communication and interface techniques disclosed herein. In examples, the client interface module 120 and vehicle interface 122 communicate over a hardwire connection or BLE. The client interface module 120 can collect various data and information generated, stored or otherwise available relating to operation of the vehicle(s) 118 via the vehicle interface 122.

The client interface module 120 is operable to receive and/or send various data and other information relating to the vehicle 118 via a communication path established with the vehicle interface 122 (e.g., OBD II port). Example OBD data includes all public parameter IDs (PIDs) (see, e.g., https://en.wikipedia.org/wiki/OBD-II PIDs) data stored or otherwise made available by the vehicle 118, such as speed, torque, RPM, pressure, temperature, fuel level, traction control readings or settings, and other information relating to the powertrain and/or other subsystems of the vehicle 118 during operation.

The client interface module 120 is operable to obtain data and other information from one or more sensors 124 and/or external data sources 126 via the interface module 120. One or more sensors 124 can be coupled to the vehicle(s) 118 to obtain data and other information relating to operation of the vehicle(s) 118, as well as operating environment or conditions such as ambient temperature, precipitation, altitude, soil conditions, topography, etc. External data sources 126 can include commercial and proprietary databases including various information relating to each vehicle 118, such as components, weight and performance characteristics by vehicle make and model.

Each client device 106 can include an onboard sensor suite or package 127 including various sensors and devices operable to sense one or more conditions of the vehicle(s) 118. The sensor package 127 can include a GPS module 128, an altimeter 129, a gyroscope 130 and/or an accelerometer 132 coupled to the environment 114, for example. In other examples, the GPS module 128, altimeter 129, gyroscope 130 and/or accelerometer 132 are offboard or external to the client device 106. The GPS module and altimeter 128, 129 are operable to communicate location, positioning and/or altitude information corresponding to the vehicle 118 and/or client device 106. An example gyroscope 130 includes a 3-axis gyroscope. An example accelerometer 132 is a 3-axis accelerometer. The GPS module 128, altimeter 129, gyroscope 130 and/or accelerometer 132 can be mounted or otherwise placed in close proximity to each respective vehicle 118. The environment 114 is operable to obtain information from the GPS module 128, altimeter 129, gyroscope 130 and/or accelerometer 132.

Portions of the functionality of the client device 106 can be incorporated into one or more external devices. In the illustrative example of FIG. 2A, an external device 107′ is coupled between an interface 122′ of vehicle(s) 118′ and a client device 106′. The client device 106′, external device 107′ and/or host device 102′ can include a respective sensor suite 127′ (indicated at 127c′, 127e′, and 127h′). Each sensor suite 120c′, 127e′, and 127h′ can include any of the sensors disclosed herein. The external device 107′ can include an interface module 120a′ configured to communicate data and other information between the interface 122′ of each vehicle 118′ and an interface module 120c′ of the client device 106′ utilizing any of the techniques disclosed herein. Each interface module 120e′, 120c′ can incorporate any and all of the functionality of the interface module 120 of FIG. 2.

The data module 121 is operable to access, collect, read and/or obtain data and other information from all available data and information sources, including any of the sources and devices disclosed herein. In examples, the data module 121 is operable to communicate data and other information between the rating module 123 and other portions of the environment 114 including the client interface module 120, display module 134 and/or sensor package 127.

The data module 121 is operable to create, store, retrieve and edit one or more gear (or vehicle) profiles 147, operator (or driver) profiles 148 and trail profiles 149, which may be stored in the database 116, for example, and which can be selected or otherwise indicated by a user interacting with the environment 114. Each gear profile 147 can correspond to a configuration of OEM and/or aftermarket equipment of the respective vehicle 118. Each operator profile 148 can correspond to a unique driver or operator identity and can be associated with one or more vehicles 118 and gear profiles 147. Each trail profile 149 can correspond to a predefined route, which can be specified by a set of geometric coordinates. The predefined route can be established prior to or subsequent to completion of an initial trail run.

The display module (or user interface) 134 can be configured to display or otherwise communicate various data and information collected, stored and/or generated by the client interface module 120, data module 121 and/or rating module 123. The display module 134 can include a display, graphical user interface (GUI), and/or one or more peripheral devices. A driver, operator or end user can interact directly or indirectly with the display module 134 or another portion of the environment 114 (e.g., via a peripheral device or another device in communication with the environment 114) to obtain various data and information relating to the system 100, and can interact with the display module 134 to set one or more parameters of the environment 114, including creation and/or editing of the profiles 147, 148, 149. For example, the user can interact with the display module 134 or another portion of the system 100 to enter gear information relating to a present configuration of the vehicle(s) 118, including base vehicle model and associated OEM equipment, aftermarket equipment, gear and accessories, to establish at least one gear profile 147 associated with the vehicle 118. The user can create a single gear profile 147 for a particular vehicle 118, or can create a set of gear profiles 147 for the vehicle 118 with each one of the gear profiles 147 corresponding to the same trail profile 149 or a different trail profile 149. The user can interact with the environment 114 to create new trail profiles 149 prior to, during or subsequent to completion of a particular trail or route.

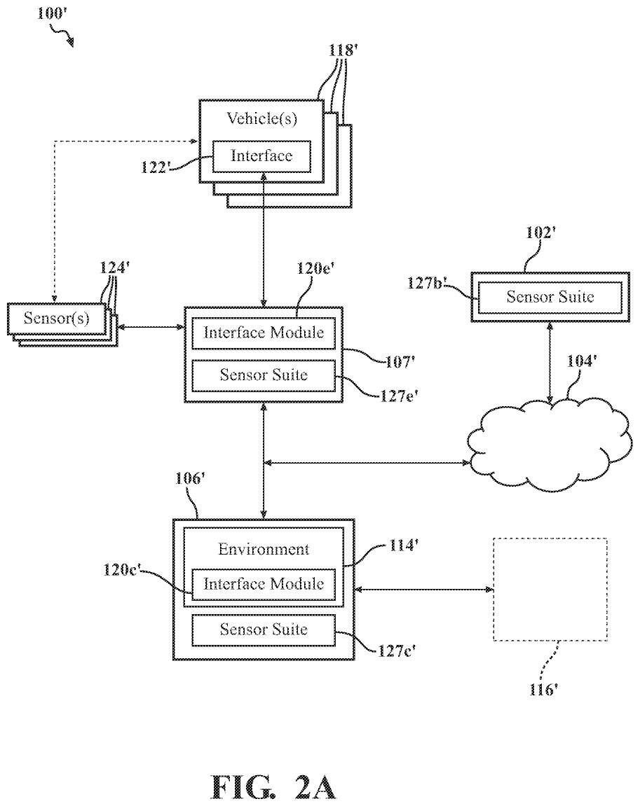

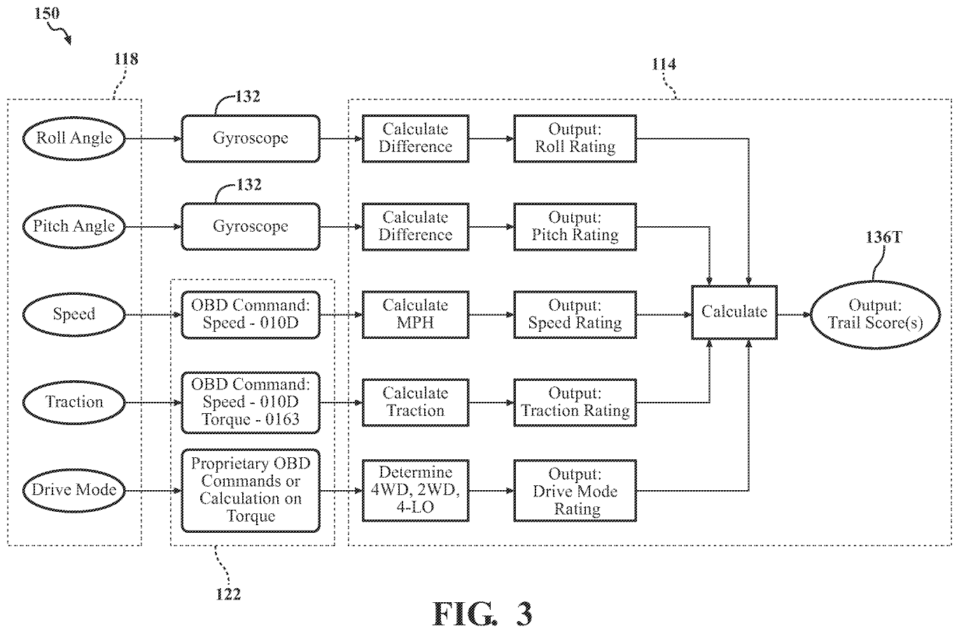

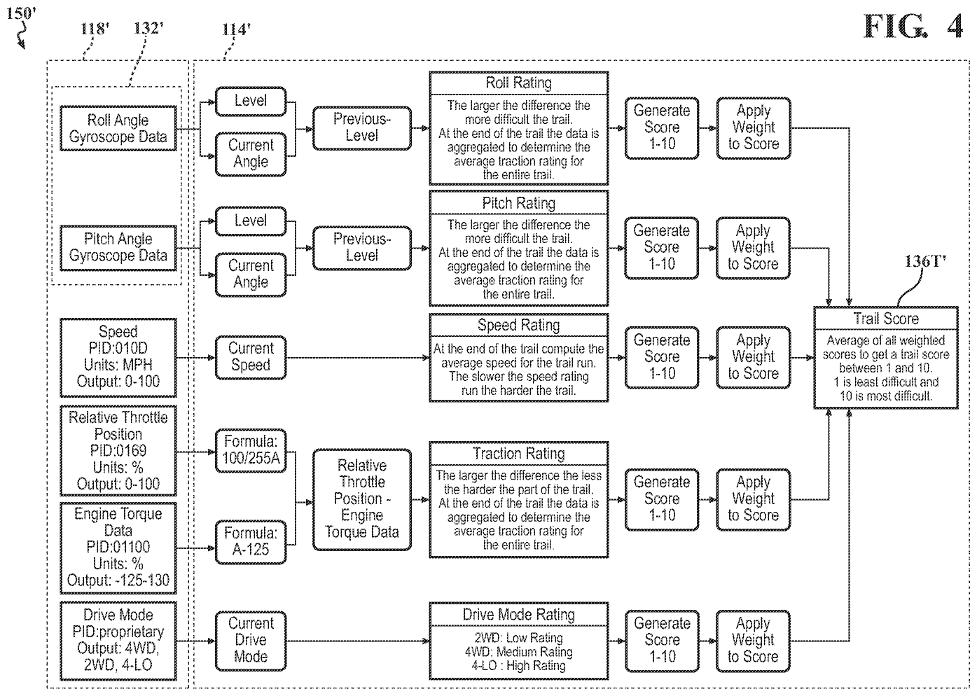

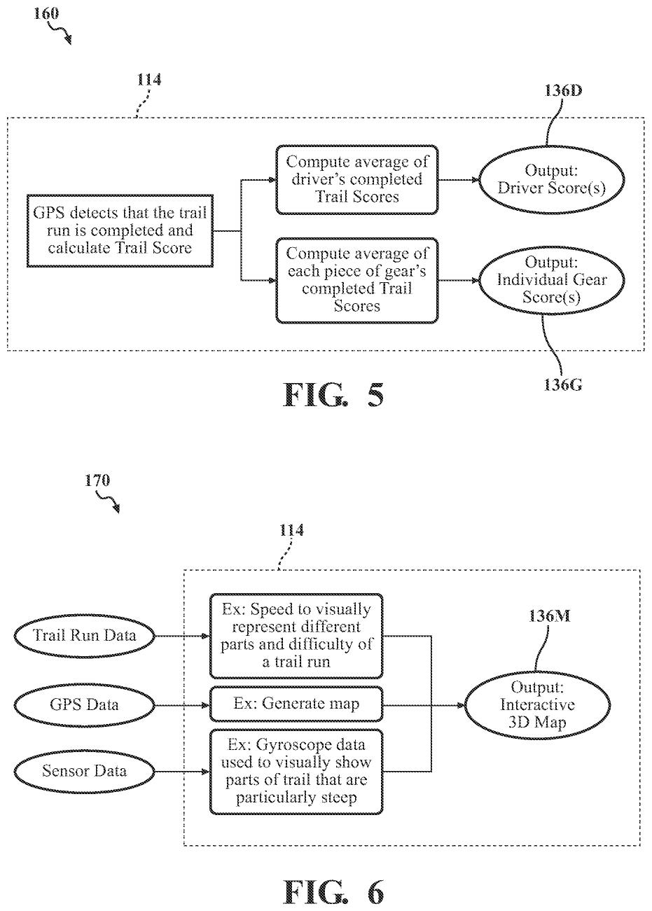

The rating module 123 is operable to collect or otherwise obtain data and information from all available data sources and utilize the data to generate one or more outputs 136 associated with operation of, or otherwise relating to, the vehicle(s) 118. Processing of the data can occur locally by a processor on the client device 106 and/or on a cloud application, for example. The outputs 136 can be displayed or otherwise communicated to various portions of the system 100, including the display module 134, and/or another device of the system 100 such as the host device 104 or another client device 106 via a user interface. The display module 134 is configured to display or otherwise communicate the outputs 136 and other related data and information to a driver, operator or user, which can occur during and/or subsequent to completion of a particular trail or route. Example outputs 136 include a trail score or difficulty rating 136T, 136T′ (FIGS. 3-4), a gear (or equipment) score 136G (FIG. 5), a driver (or operator) score 136D (FIG. 5) and a trail map 136M (FIG. 6).

The rating module 123 is operable to generate at least one, or more than one, trail score 136T, individual and/or collective gear score 136G, driver score 136D and/or trail map 136M in response to operation of the vehicle(s) 118 over at least predefined route corresponding to a respective one of the trail profiles 149 associated with the vehicle(s) 118. The rating module 123 includes a set of sub-modules 138 including a trail score sub-module 140, a driver score sub-module 142, a gear score sub-module 144 and a trail map sub-module 146.

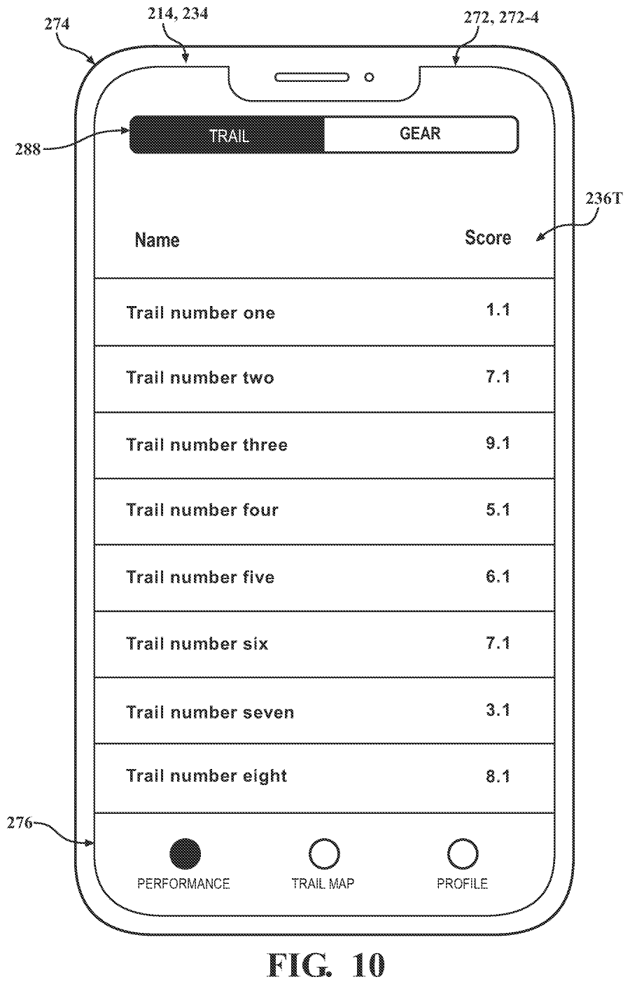

The trail score sub-module 140 is operable to generate one or more trail scores 136T for each vehicle 118 and associated gear profile(s) 147 (see, e.g., FIG. 10). The driver score sub-module 142 is operable to generate one or more driver scores 136D for each driver or operator associated with one or more vehicles 118 and gear profile(s) 147. The gear score sub-module 144 is operable to generate one or more gear scores 136G for each vehicle 118 and gear profile 147. The trail map sub-module 140 is operable to generate one or more trail maps 136M for each trail or predefined route associated with a respective trail profile 149. Each score 136T, 136G, 136D, trail map 136M and/or other output 136 can be generated during or subsequent to completion of each trail or route, and can be generated for performance or completion of a portion or entirety of the respective trail or route by the vehicle 118.

Each score 136T, 136G, 136D can be indicated as a value in a predefined range, such as a value of 1-10 or 0-100. Each score 136T, 136G, 136D can be an absolute value, an average or weighted value, a relative value based on a benchmark, and/or one or more previous scores or values associated with the vehicle 118, operator or population of scores 136T, 136G, 136D in the database 116 associated with a plurality of vehicles 118 and/or profiles 147, 148, 149. For example, the gear score 136G can be generated based on a comparison of each vehicle 118 or gear profile 147 in the database 116 (FIG. 1) such as gear profiles 147 having the same hardware configuration or at least one or more common OEM and/or aftermarket hardware components. Gear scores 136G can be generated for each individual component, a set or collection of components, or an overall score for all components of the vehicle 118 associated with the gear profile 147.

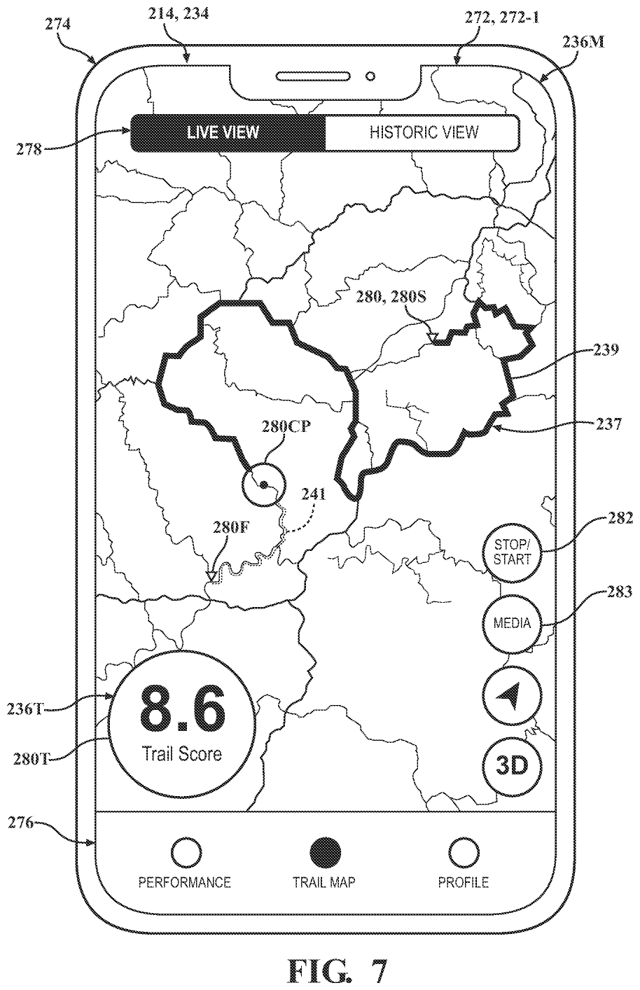

While the operator is performing a trail run with the vehicle 118, data and other information is collected from multiple sources including any of the devices disclosed herein. The driver or operator can interact with the display module 134 or another portion of the environment 114 to manually indicate the start and finish of a trail run or route associated with a respective trail profile 149 (see, e.g., FIG. 7). In other examples, the rating module 123 is operable to automatically determine an occurrence of the start and finish of a trail run utilizing various data and information from the system 100 including position information from the GPS module.

Referring to FIGS. 3-4, with continuing reference to FIG. 2, exemplary methods or processes of generating a trail score or difficulty rating 136T are disclosed in flowcharts 150, 150′. In examples, the trail score sub-module 140 or another portion of the environment 114 is configured to execute the method 150/150′. Using the data and other information collected on a trail run, the method 150/150′ generates trail scores 136T/136T′ for each vehicle 118. The method 150/150′ is operable to associate the trail scores 136T/136T′with each respective trail profile 149, gear profile 147 and/or operator profile 148. It should be understood that any of steps of flowchart 150 can be incorporated into the flowchart 150′, and vice versa, to generate the trail scores 136T/136T′.

Various techniques can be utilized to generate each trail score 136T/136T′. Trail scores 136T/136T′ can be established across a range of values between 1 and 10, with 1 being the easiest and 10 being the most difficult, for example. The trail score 136T/136T′ can be primarily weighted or determined based on a difficulty of the trail or predefined route, as calculated based on indicators such as gyroscope data from gyroscope 130 for relatively significantly steep ascents or descents on a hill. Other attributes of the calculated trail score 136T/136T′ can include a “fast” trail or a “slow” trail based on an elapsed time and/or a speed of the vehicle(s) 118 completing the respective trail or predefined route. For example, slow trails may generally be more difficult. In examples, a difficulty of the terrain associated with the calculated trail score 136T/136T′ and trail profile 149 is generated or otherwise determined based on traction control data obtained from the vehicle 118 during execution of the trail run.

Various criteria can be utilized to declare a successful run or completed trail or route. In examples, for a run to be successful the vehicle 118 can be required to complete the entire trail with the specific gear on the vehicle 118 corresponding to the respective gear profile 147, as indicated by GPS recordings from the GPS module 128 corresponding to the trail profile 149 of the respective trail or route.

Referring to FIG. 5, with continuing reference to FIG. 2, an exemplary method or process of generating a driver score 136D and/or gear score 136G is disclosed in a flowchart 160. In examples, the driver score sub-module 142 and gear score sub-module 144 or another portion of the environment 114 are configured to execute the method 160. The method 160 is operable to associate each driver score 136D with each respective operator profile 148. The method 160 is operable to associate each gear score 136G with each respective gear profile 147 and trail profile 149.

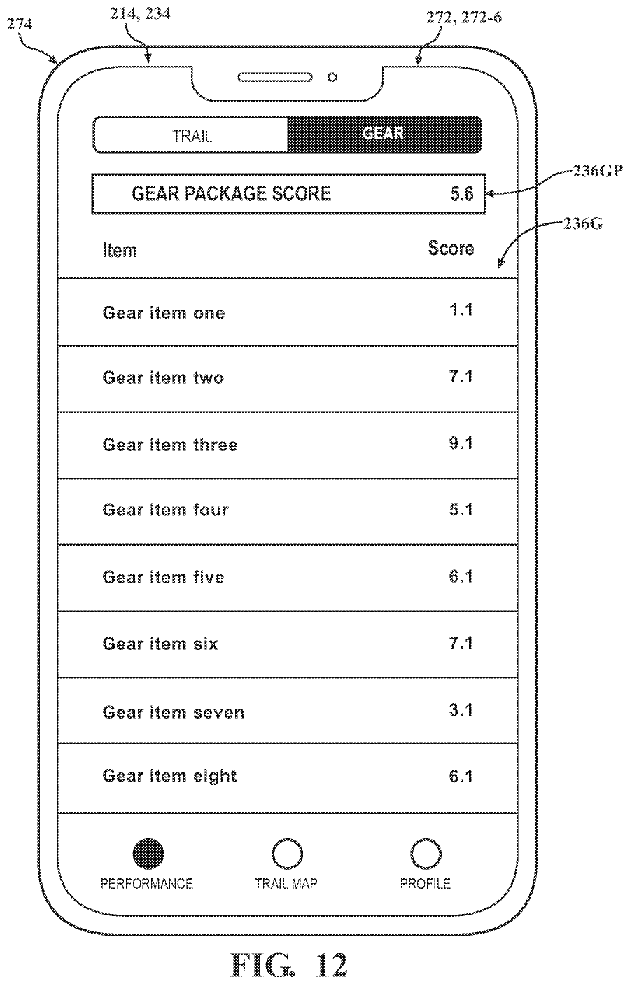

Various techniques can be utilized to generate each driver score 136D and gear score 136G. In examples, method 160 includes determining an average of the generated trail scores 136T/136T′ for a respective trail profile 149 and the generated gear scores 136G to assign an individual score to each piece of gear or hardware of the vehicle 118 upon a successful completion of a trail run. Gear scores 136G can be established across a range of values between 1and 10, with a value of 1 being gear used on the easiest trails and a value of 10 being gear used on the most difficult trails, which can be based on the trail scores 136T/136T′ generated by the method 150. In examples, gear scores 136G of each individual piece of gear or equipment of the respective vehicle 118, as indicated in or associated with the respective gear profile 147, can be calculated by aggregating successful trail run trail scores 136T/136T′. Calculation of each gear score 136G can exclude (or include) user input or rating. In examples, gear scores 146G are generated or assigned for a set or collection of gear or equipment and/or all gear or equipment that is present on and associated with the respective vehicle 118 (see, e.g., FIG. 12).

In examples, method 160 includes generating a list of recommended gear or equipment for each trail profile 149 based on aggregated gear scores 136G and a total number of successful trail runs performed by using the recommended gear for the population of gear profiles 147 and/or operator profiles 148. The method 160 can include creating or editing a gear profile 147 corresponding to the list of recommended gear, which can be specific to vehicle make and model, for example.

In examples, method 160 includes generating and assigning each driver score 136D based on averaging the generated trail scores 136T/136T′ for a trail or predefined route upon a successful completion. Driver scores 136D can include a range of values between 1 and 10, with a value of 1 indicating drivers who have completed the easiest trails and a value of 10 being drivers who have completed the most difficult trails, for example. The trail profiles 149 can be ranked from easiest to hardest, for example. The driver scores 136 can be calculated by aggregating successful trail scores 136T/136T′.

Referring to FIG. 6, with continuing reference to FIG. 2, an exemplary method or process of generating and updating a trail map 136M is disclosed in a flowchart 170. In examples, the trail map sub-module 146 or another portion of the environment 114 is configured to execute the method 170.

The method 170 is operable to generate an interactive two-dimensional (2D) and/or three-dimensional (3D) map of a trail or route overlaid on real world topography utilizing GPS and altitude data recorded on a trail run by the sensor suite 127, for example. The method 170 is operable to place present and/or prior positions of the vehicle(s) 118 along a respective trail map or course, which can be stored in memory for later retrieval. The trail map and other related information can be stored in or otherwise associated with a respective trail profile 149. In examples, the data for the trail map can be generated in the cloud and displayed in the display module 134 or another portion of the system 100. The method 170 is operable to highlight or otherwise identify relatively difficult areas or segments along the trail run or route based on various indicators and data such as gyroscope data from the gyroscope 130 associated with relatively significantly steep ascents or descents on a hill, for example. The method 170 is operable to place other indicators on the map such as “fast” segment(s) and/or “slow” segment(s) along the trail run or course using indicia such as different color coding based on recorded data such as speed from the accelerometer 132. In examples, the user can interact with the display module 134 to upload and associate photos, videos and other media with specific locations along the trail map, which can be linked to or otherwise associated with the respective trail profile 149.

FIGS. 7-12 illustrate exemplary display screens 272 that may be incorporated into a display module 234 or another portion of a trail rating environment 214. In this disclosure, like reference numerals designate like elements where appropriate and reference numerals with the addition of one-hundred or multiples thereof designate modified elements that are understood to incorporate the same features and benefits of the corresponding original elements. The display screens 272 are indicated at 272-1 to 272-6 in FIGS. 7-12, respectively. The display screens 272 may be generated and updated utilizing any of the techniques disclosed herein, including any of the steps of the disclosed methods 150, 150′, 160, 170, and may be incorporated into any of the systems disclosed herein, including system 100, 100′. Each screen 272 may be displayed on a display device 274. The display device 274 may be the host device 102 and/or client device(s) 106, 106′ of the system 100, 100′, such as a smart phone, for example.

Referring to FIG. 7, screen 272-1 illustrates a live view of a trail map 236M. The trail map 236M may be selected by user interaction with a first interface item 276. The first interface item 276 may be a menu including various menu items such as a performance button, trail map button, and profile button.

The live view may be selected by user interaction with a second interface item 278. The second interface item 278 may be a set of toggle buttons, for example. The user may interact with the second interface item 278 to select between a live view mode and a historic view mode. The display module 234 may be operable to generate one or more indicators or icons 280, including a start position icon 280S, current position icon 280CP and/or finish position icon 280F along a trail route or route 237. The trail route 237 may be a predefined trail route or may be generated based upon movement of the vehicle relative to the trail map 236M. The start position icon 280S and finish position icon 280F may be positioned at opposed ends of the trail route 237 automatically in response to selection of a predefined trail route 237 or in response to user interaction.

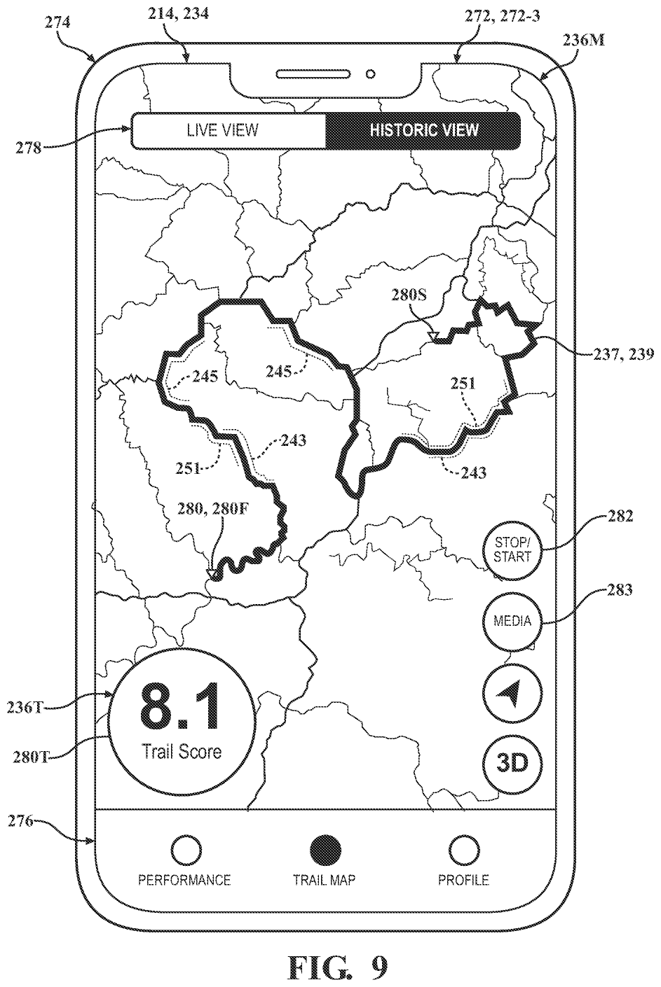

The user can interact with the screen 272-1 to manually indicate the start and finish of the trail run 237 associated with a respective trail profile 119, as illustrated by the start position icon 280S and finish position icon 280F (see also FIG. 9). In some implementations, the finish of the trail route may be declared through user interaction with a start/stop button 282.

The current position icon 280CP may be generated and updated to indicate a current position of the vehicle along the trail route 237 relative to the trail map 236M. A completed portion of the trail route 237 may be indicated by completed segment 239 (indicated in solid lines in FIGS. 7 and 9 for illustrative purposes). An incomplete portion of the trail route 237 may be indicated by incomplete segment 241 (indicated in dashed line in FIG. 7 for illustrative purposes).

The display module 234 may be operable to set the finish position icon 280F to the position of the current position icon 280CP in response to selection of the start/stop button 282. A completed trail route 237 is illustrated in screen 272-3 of FIG. 9.

A trail score 236T may be displayed in a trail score icon 280T. The trail score 236T may be generated and updated in response to movement of the vehicle relative to the trail route 237. For example, the trail score 236T may be associated with a value of 8.6 based upon the completed segment 239 of the trail route 237 as illustrated in FIG. 7, and the trail score 236T may be associated with a value of 8.1 based upon completion of the trail route 237 as illustrated in the screen 272-3 of FIG. 9.

The user can interact with an interface item 283 (e.g., media button) in screen 272-1 and/or screen 272-3 to upload and associate photos, videos and other media with specific locations along or adjacent to the trail route 237, which can be linked to or otherwise associated with the respective trail profile 149. The specific location can be the current position of the vehicle along the trail route 237 and/or any other position along or adjacent to the trail route 237 or any other position along the trail map 236M selected by the user.

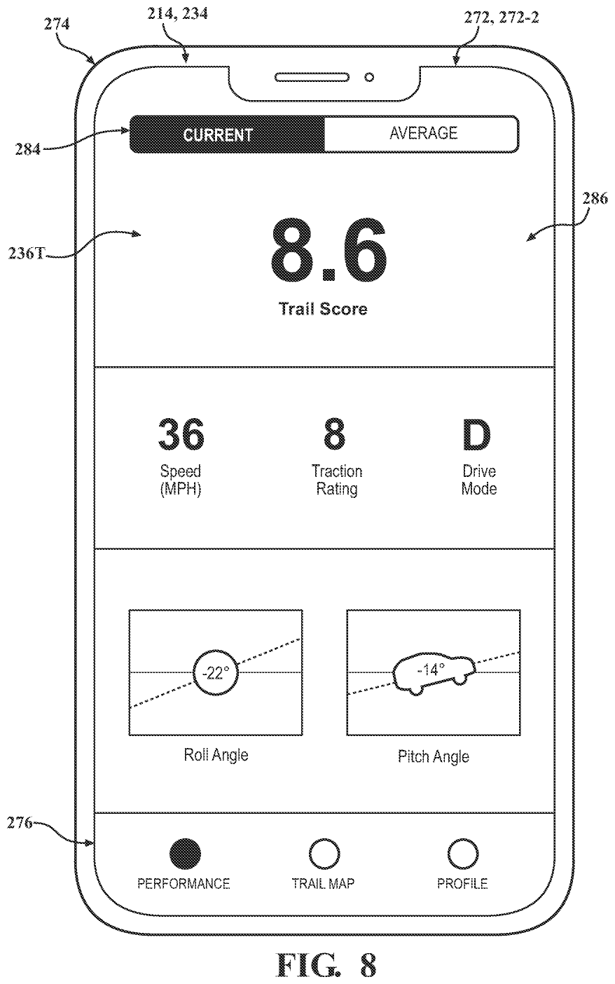

Referring to FIG. 8, the user may interact with the menu 276 to view various performance information 286 as illustrated by screen 272-2. Current and average (or historic) performance information 286 may be selected by user interaction with a third interface item 284. The third interface item 284 may be a set of toggle buttons, for example. The user may interact with the third interface item 284 to select between the current and average performance information 286. The current performance information may be associated with the current position of the vehicle relative to the trail route 237 or trail map 236M. The average performance information may be associated with an average value of the performance information 286 with respect to the completed segment 239 of the trail route 237 (e.g., since the start of the trail route 237). Exemplary performance information 286 can include any of the performance information disclosed herein, including a value of the trail score 236T, speed, traction rating, drive mode, roll angle and/or pitch angle, as illustrated in FIG. 8. Other exemplary performance information can include torque, RPM, pressure, fuel level, traction control reading and/or traction control setting, for example.

Referring to FIG. 9, the screen 272-3 may be configured to highlight or otherwise identify relatively difficult areas or segments 243 along the trail route 237 by placing one or more indicators on the trail map 236M. The screen 272-3 may be configured to place other indicators on the trail map 236M such as “fast” segment(s) 245 and/or “slow” segment(s) 251 along the trail route 237. The segments 243, 245, 251 may be generated utilizing any of the data, other information and techniques disclosed herein. The segments 243, 245, 251 may be displayed utilizing any of the indicia disclosed herein (shown in dashed lines for illustrative purposes).

Referring to FIG. 10, the user may interact with the menu 276 to view and/or update various profile information as illustrated by screen 272-4. The user may interact with a fourth interface item 288 to select between trail performance and gear performance and profile information. The fourth interface item 288 may be a set of toggle buttons, for example. The user may interact with the fourth interface item 288 to select between the trail and gear performance information. Screen 272-4 illustrates the trail performance information including a set of trail scores 236T. The trail scores 236T may be associated for the same and/or different trail routes 237. The trail route 237 of FIG. 9 may correspond to “Trail number eight” of the set of trail scores 236T, for example.

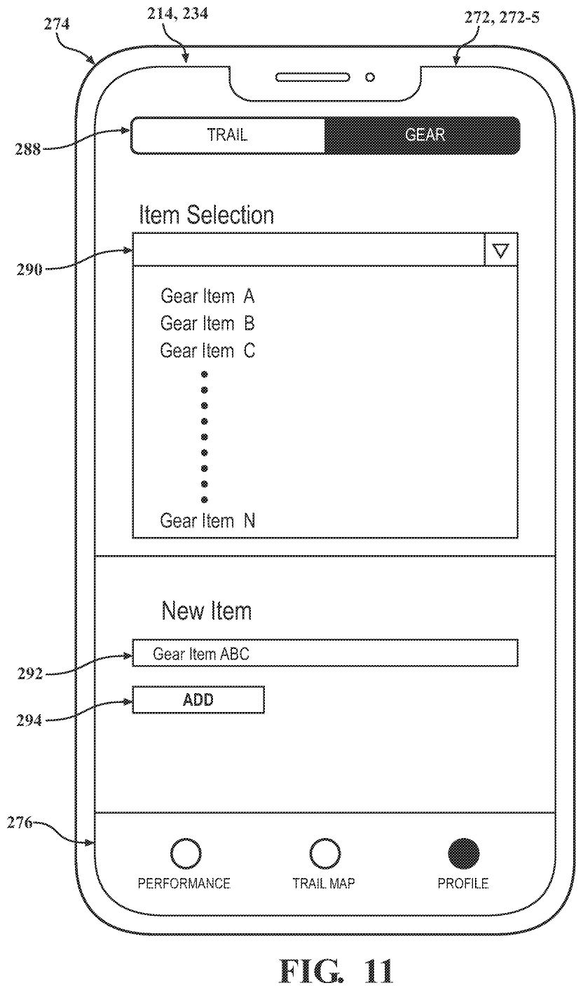

Referring to FIG. 11, the user can interact with the fourth interface item 288 to view and/or update various gear profile information associated with a respective vehicle. The operator may interact with screen 272-5 to set or select a gear configuration associated with the respective vehicle to establish or update a respective gear profile 147. The screen 272-5 may include a drop-down list 290 to select a particular gear item from a predetermined list. The predetermined list may be categorized based on one or more categories (e.g., powertrain, suspension, electrical, etc.) and sub-categories (e.g., engine, transmission, etc.) based on vehicle type, for example. Each predetermined list may be stored in the database(s) 116, for example. The screen 272-5 may include a text box 292 for manual entry of gear item(s) by the user. The environment 214 may be operable to associate entries in the text field 292 with entries in the database(s) 116 and may be operable add new entries in the database 116 upon entry of text in the text field 292 and selection of a button 294, for example.

Referring to FIG. 12, the user may view gear performance information including one or more gear scores 236G associated with individual gear items in screen 272-6. The gear scores 236G may be associated with a respective gear profile 147 in the database 116, for example. The values of each of the gear scores 236G may correspond to a single trail route 237 or may be average values corresponding to two or more trail routes 237. The trail routes 237 may be the same or may differ for each of the gear items. A gear package score 236GP may be generated based on an average value of the individual gear scores 236G, for example.

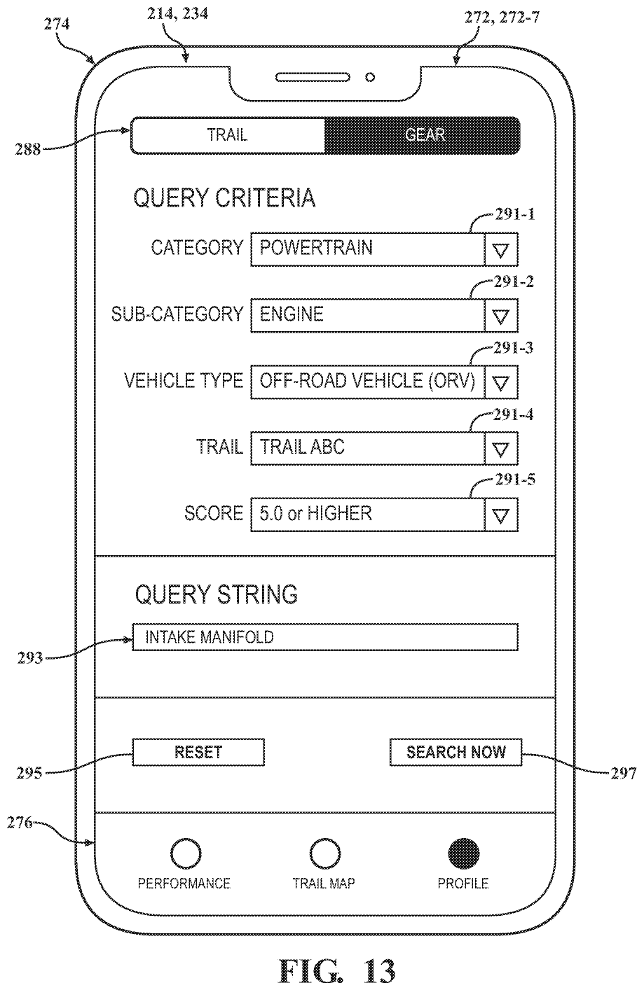

Referring to FIG. 13, the user may interact with display screen 272-7 to query the database 116 and/or other sources to obtain one or more with aggregated gear scores 236G associated a population of gear profiles 147 in the database 116. Various techniques may be utilized to form the queries. The user may specify at least one criterion or a set of criterion to form the query. For example, the screen 272-7 may include one or more drop-down lists 291. The drop-down lists 291 may correspond to any of the arrangements and information disclosed herein. For example, the drop-down lists 291 may include a category list 291-1 (e.g., powertrain, suspension, electrical, etc.), sub-category list 291-2 (e.g., engine, transmission, etc.), vehicle type list 291-3 (e.g., on-road, all-terrain vehicles (ATV), off-road vehicles (ORV), electric bicycles, etc.), trail list 291-4 and score list 291-5. The trail list 291-4 may be associated with the trail profiles 149 in the database 116 and/or other trails, and may include an individual trail and/or group of trails (e.g., based on difficulty, geography, etc.). The score list 291-5 may be utilized to select a range or threshold of gear scores (e.g., 5 or higher, between 7.0 and 9.0, 9.0 or higher, etc.). The user may interact with one or more of the lists 291 to form a desired query. Although a quantity of five lists 291 are shown, it should be understood that the lists 291 are illustrative and fewer or more than a quantity of five lists 291 may be utilized.

The screen 272-7 may include a text box 293 for manual entry of criterion for forming the criteria by the user. The environment 214 may be operable to associate entries in the text field 293 with entries in the database(s) 116 based on partial and/or complete matches, for example. Entries in the text box 293 may be utilized independently and/or to further limit the criteria specified in the lists 291.

The user may interact with a button 295 to reset the query criteria. The user may interact with a button 297 to execute the query according to the criteria specified in the screen 272-7 including the lists 291 and/or text box 293.

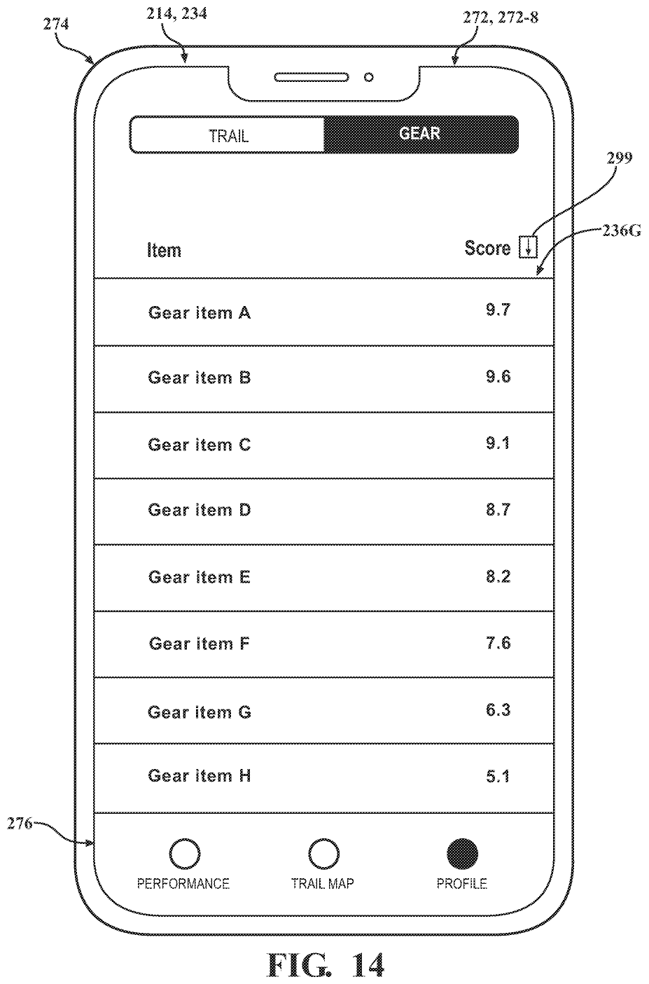

Referring to FIG. 14, the results of a prior query for gear or equipment may be presented to the user in the display screen 272-8 in response to execution of the prior query. The environment 214 may be operable to generate a filtered list of gear or equipment from aggregated gear scores 236G in the database 116 in response to and based on a prior query by the user, such as through interaction with the screen 272-7, and display the filtered list of gear or equipment in the screen 272-8. The screen 272-8 may be presented or displayed to the user in response to selection of the button 297 of the screen 272-7 and/or other user interaction with the user interface 234, for example. The environment 214 may be operable to store prior queries which may be selected by the user at a later time for viewing the respective results.

The screen 272-8 may present gear scores 236G for respective gear or equipment items meeting the criteria specified in the query. The user may interact with a button 299 to sort the scores by value in descending and/or ascending order. Each of the gear items in the display screen 272-8 may be hyperlinked to one or more sources for obtaining various details of the respective item and purchasing the item. The sources may include any of the sources disclosed herein, including the external data sources 126, third party websites and marketplaces, etc.

Although the different examples have the specific components shown in the illustrations, embodiments of this disclosure are not limited to those particular combinations. It is possible to use some of the components or features from one of the examples in combination with features or components from another one of the examples.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A trail rating system comprising:
a processor and memory operable to execute a trail rating environment; and
wherein the trail rating environment comprises:
an interface module operable to communicate with a vehicle interface of at least one vehicle;
a data module operable to access one or more gear profiles, one or more operator profiles and one or more trail profiles;
a trail rating module operable to generate at least one trail score, at least one gear score, at least one driver score and at least one trail map in response to operation of the at least one vehicle over at least one predefined route, wherein the at least one predefined route corresponds to a respective one of the one or more trail profiles; and
a display module including a user interface operable to display information relating to the at least one trail score, the at least one gear score, the at least one driver score and the at least one trail map.

2. The trail rating system as recited in claim 1, wherein the interface module is operable to receive data corresponding to two or more of the following over a communication path established between the interface module and the vehicle interface: speed, torque, RPM, pressure, temperature, fuel level, traction control reading, traction control setting, and drive mode.

3. The trail rating system as recited in claim 2, wherein the vehicle interface comprises an on-board diagnostics port.

4. The trail rating system as recited in claim 1, wherein:
the interface module is operable to obtain operational data relating to operation of the at least one vehicle from one or more sensors;
the one or more sensors include at least one of the following: a GPS module, an altimeter, a gyroscope and an accelerometer; and
the operational data includes at least one of the following: location, ambient temperature, precipitation, altitude, soil condition and/or topography.

5. The trail rating system as recited in claim 1, wherein the data module is operable to access the one or more gear profiles, the one or more operator profiles and the one or more trail profiles in a database.

6. The trail rating system as recited in claim 5, wherein the data module is operable to edit the one or more gear profiles, the one or more operator profiles and the one or more trail profiles in the database in response to user interaction.

7. The trail rating system as recited in claim 6, wherein:
each of the one or more gear profiles corresponds to a configuration of equipment associated with the at least one vehicle;
each of the one or more operator profiles corresponds to a unique operator identity; and
each of the one or more trail profiles corresponds to a predefined route associated with a set of geometric coordinates.

8. The trail rating system as recited in claim 7, wherein:
the display module is operable to cause the configuration of equipment to be set for the respective one or more gear profiles in response to user interaction.

9. The trail rating system as recited in claim 8, wherein:
the configuration of equipment comprises aftermarket equipment.

10. The trail rating system as recited in claim 7, wherein:
the database is operable to store a plurality of gear profiles associated with a plurality of vehicles; and
the trail rating module is operable to generate the at least one gear score based on a comparison of each gear profile of the plurality of gear profiles in the database having one or more aftermarket hardware components in common with the one or more gear profiles.

11. The trail rating system as recited in claim 1, wherein:
the at least one vehicle includes an all-terrain vehicle or an off-road vehicle.

12. A method of trail rating for a vehicle comprising:
accessing at least one gear profile corresponding to a configuration of equipment of a respective vehicle;
accessing at least one operator profile;
accessing at least one trail profile corresponding to at least one predefined route, wherein the at least one predefined route is associated with a set of geometric coordinates;
obtaining data from a vehicle interface of the respective vehicle in operation over the at least one predefined route;
generating at least one trail score, at least one gear score, at least one driver score and at least one trail map based on the obtained data; and
displaying information in a user interface relating to the at least one trail score, the at least one gear score, the at least one driver score and the at least one trail map.

13. The method as recited in claim 12, further comprising:
setting the configuration of equipment in response to user interaction with the user interface.

14. The method as recited in claim 13, wherein:
the configuration of equipment comprises aftermarket equipment; and
the vehicle is an all-terrain vehicle or an off-road vehicle.

15. The method as recited in claim 12, wherein:
the step of accessing the at least one gear profile includes accessing the at least one gear profile from a plurality of gear profiles in a database; and
the step of generating the at least one trail score occurs in response to comparing each gear profile of the plurality of gear profiles in the database having one or more aftermarket hardware components in common with the at least one gear profile.

16. The method as recited in claim 15, wherein the step of accessing the at least one trail profile includes accessing the at least one trail profile in the database, wherein the database is operable to store a plurality of trail profiles, and further comprising:
generating a list of recommended equipment for the at least one trail profile based on aggregated gear scores in the database and a total number of successful trail runs performed by using the list of recommended equipment for a population of gear profiles in the database.

17. The method as recited in claim 12, further comprising:
setting a start and a finish of a trail route associated with the at least one predefined route in response to user interaction with the user interface; and
declaring a successful run in response to determining completion of the trail route with the configuration of equipment.

18. The method as recited in claim 12, wherein:
the step of generating the at least one trail score includes generating a plurality of trail scores for the at least one predefined route, each of the plurality of trail scores associated with the at least one operator profile; and
the step of generating the at least one driver score is based on averaging the plurality of the trail scores.

19. The method as recited in claim 12, wherein:
the obtained data corresponds to two or more of the following: speed, torque, RPM, pressure, temperature, fuel level, traction control reading, traction control setting, and drive mode; and
the step of generating the at least one trail score comprises:
generating a roll rating associated with gyroscopic data from a gyroscope associated with the vehicle;
generating a pitch rating associated with the gyroscopic data;
generating a speed rating associated with the speed and an elapsed time;
generating a traction rating associated with the traction control reading and the traction control setting; and
generating a drive mode rating associated with the drive mode.

20. The method as recited in claim 12, further comprising:
generating a first indicator based on gyroscopic data from a gyroscope associated with the vehicle;
generating a second indicator based on speed from an accelerometer associated with the vehicle;
displaying the first indicator on the at least one trail map to identify a first segment along the at least one predefined route; and
displaying the second indicator on the at least one trail map to identify a second segment along the at least one predefined route.

21. The method as recited in claim 15, further comprising:
generating a filtered list of gear equipment based on aggregated gear scores in the database and according to at least one criterion being set by user interaction with the user interface; and
displaying the filtered list of gear equipment.
